(19) United States
(12) Patent Application Publication
(10) Pub. No.: US 2023/0416454 A1
(43) Pub. Date: Dec. 28, 2023

(54) METHOD FOR SYNTHESIZING PEF

(71) Applicants: COMPAGNIE GENERALE DES ETABLISSEMENTS MICHELIN, Clermont-Ferrand (FR); Centre National De La Recherche Scientifique (CNRS), Paris (FR); Universite Claude Bernard-Lyon1, Villeurbanne (FR); Universite Jean Monnet Saint Etienne, Saint-Etienne Cedex 2 (FR); INSA Lyon, Villeurbanne (FR)

(72) Inventors: MARC SUTTER, Clermont-Ferrand (FR); CHRISTOPHE LE CLERC, Clermont-Ferrand (FR); MELISSA POLONI, VILLEURBANNE (FR); MARION COLELLA, VILLEURBANNE (FR); FRANCOISE FENOUILLOT-RIMLINGER, VILLEURBANNE (FR); JULIEN BERNARD, Villeurbanne (FR)

(21) Appl. No.: 18/265,120

(22) PCT Filed: Nov. 29, 2021
(86) PCT No.: PCT/FR2021/052116

§ 371 Date: Jun. 2, 2023

(30) Foreign Application Priority Data
Dec. 4, 2020 (FR) 2012691

(51) Int. Cl. C08G 63/672; C08G 63/85

(52) U.S. Cl. CPC C08G 63/672; C08G 63/85; C08G 2250/00

(57) ABSTRACT

A polyester comprises ethylene 2,5 furandicarboxylate units and diethylene glycol units, the polyester having a melting temperature Tf of greater than or equal to 225° C., an intrinsic viscosity of greater than or equal to 0.65 dL/g, and in which the amount of diethylene glycol unit, denoted DEG, is less than 4 mol % and the quantity of ester functions in chain end situations is less than 100 meq/kg. A process for producing the polyester is disclosed.

### TECHNICAL FIELD OF THE INVENTION

The present invention relates to the field of polyesters and of processes for manufacturing polyesters.

### PRIOR ART

There are numerous known applications for polyesters in the industrial and textile sectors. The variety of their application is such that the volumes produced each year are very high. There is also advantage in synthesizing polyesters from monomers obtained from renewable resources, these polyesters having technical features which allow them to be substituted for petroleum-based polyesters such as polyethylene terephthalate (PET).

Numerous research studies have been conducted for producing polyesters from furandicarboxylate monomers. The reason is that these monomers can be produced from natural resources such as sugars. The synthesis of the polyester typically comprises a step of esterification and a step of polycondensation, which is optionally followed by steps of crystallization and of solid-state post-condensation for the purpose of adjusting the properties of the polyester. The procedure in these various steps determines the structure, and therefore the characteristics, of the polyester obtained.

For example, patent application WO 2015/137805 describes a polyethylene furanoate (PEF) polyester having a low proportion of diethylene glycol units and a process for synthesizing it. The synthesis comprises, more particularly, steps of esterification, in the presence of a compound which suppresses the formation of diethylene glycol, and of polycondensation. The presence of this suppressor compound results in a very low quantity of diethylene glycol units in the PEF and therefore improves the melting temperature and the degree of crystallinity of the polyesters obtained.

Research studies have been conducted into the synthesis of high molecular weight PEF, more particularly for uses in the packaging sector in the form of films, comprising transesterification and melt polycondensation steps (Polymers 2018, 10, 471; Polym. Chem. 2017, 8, 6895-6908). However, the operating conditions used do not produce polymers with a melting temperature exceeding 220° C.

Continuing its research studies, the Applicant has found a polyethylene furanoate polyester having a melting temperature, a viscosity and a degree of crystallinity that are improved, and exhibiting excellent processability. This polyester may be obtained by the combination of steps and of particular operating conditions which constitute an improvement to the processes known from the prior art.

### DETAILED DESCRIPTION OF THE INVENTION

The invention relates to at least one of the following embodiments:

1. Polyester comprising ethylene 2,5-furandicarboxylate units and diethylene glycol units, said polyester having a melting temperature Tf of greater than or equal to 225° C., an intrinsic viscosity of greater than or equal to 0.65 dL/g, and in which:
the amount of diethylene glycol unit, denoted DEG, is less than 4 mol %,
the quantity of ester functions in chain end situations is less than 100 meq/kg.

2. Polyester according to the preceding embodiment, wherein the DEG content is less than 3 mol %, preferably less than 2 mol %.

3. Polyester according to either of the preceding embodiments, wherein the melting temperature Tf is greater than or equal to 230° C.

4. Polyester according to any one of the preceding embodiments, having a dispersity of less than 1.9, preferably of between 1.7 and 1.9.

5. Polyester according to any one of the preceding embodiments, wherein the quantity of ester functions in chain end situations is less than 80 meq/kg, and preferably less than 70 meq/kg.

6. Polyester according to any one of the preceding embodiments, wherein the intrinsic viscosity is between 0.65 and 0.90 dL/g.

7. Polyester according to any one of the preceding embodiments, wherein the glass transition temperature T_{g} is of between 70 and 90° C.

8. Process for preparing a polyester, comprising successively:
a step of transesterifying a composition comprising a furandicarboxylate compound, denoted RFC, of general formula (I)

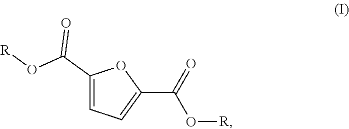

in which R represents an alkyl group comprising from 1 to 3 carbon atoms or the hydrogen atom, said composition also comprising ethylene glycol, denoted EG, this transesterifying step being operated at an increasing temperature in the range from 150° C. to at least 185° C. with a molar ratio EG/RFC of from 3 to 1.3 in the presence of a Lewis acid catalyst;
a melt polycondensation step operated at an increasing temperature within the range from 220° C. to 250° C. and a pressure of less than 100 mbar, to give a polyester.

9. Process according to the preceding embodiment, wherein R in the compound of general formula (I), represents an alkyl group comprising from 1 to 2 carbon atoms.

10. Process according to either of embodiments 8 and 9, wherein the transesterifying step is carried out for a time of from 1 to 5 h, preferably from 2 to 4 h.

11. Process according to any one of embodiments 8 to 10, wherein the highest temperature at which the transesterifying step is operated is within the range from 185° C. to 205° C., preferably from 185° C. to 200° C., and very preferably from 190° C. to 200° C.

12. Process according to any one of embodiments 8 to 11, wherein the temperature in the transesterifying step increases continuously within the range from 160° C. to at least 185° C. according to a ramp of less than or equal to +1° C./min, preferably less than or equal to +0.5° C./min.

13. Process according to any one of embodiments 8 to 11, wherein the temperature in the transesterifying step increases within the range from 160° C. to at least 185° C. in stages of within a range from 5 to 15° C.

14. Process according to the preceding embodiment, wherein each stage lasts independently for from 15 min to 2.5 h.

15. Process according to any one of embodiments 8 to 14, wherein the time between the end of the first stage and the start of the last stage, or between the lowest and highest temperatures in the transesterifying step when the temperature increases continuously, is at least 30 min.

16. Process according to any one of embodiments 8 to 15, wherein the catalyst used in the transesterifying step is selected from hafnium acetylacetonate, zirconium acetylacetonate, titanium isopropoxide and titanium tetrabutoxide, and preferably is titanium tetrabutoxide.

17. Process according to any one of embodiments 8 to 16, wherein the molar ratio EG/RFC in the transesterifying step is from 2 to 1.5.

18. Process according to any one of embodiments 8 to 17, wherein the transesterifying step is operated at a pressure of from 0.8 to 2 bar, preferably from 800 to 1700 mbar.

19. Process according to any one of embodiments 8 to 18, wherein the polycondensation step is operated at an increasing temperature in the range of from 220° C. to 250° C.

20. Process according to any one of embodiments 8 to 19, wherein the polycondensation step is operated at an increasing temperature in the range of from 225° C. to 240° C. via stages of within a range of from 2 to 10° C.

21. Process according to the preceding embodiment, wherein each stage lasts independently for from 15 min to 2.5 h.

22. Process according to any one of embodiments 8 to 21, wherein the polycondensation step is operated at a pressure of less than 50 mbar.

23. Process according to any one of embodiments 8 to 22, wherein, following the polycondensation step, a shaping step is performed in which the polycondensate is cooled rapidly by contacting with water and is pelletized, and then dried at a temperature of from 80° C. to 100° C. at a pressure less than or equal to the atmospheric pressure in an inert atmosphere.

24. Preparation process according to the preceding embodiment, wherein, following the shaping step, a crystallizing step is carried out, which is operated at a temperature of from 150° C. to 210° C. for a time of from 15 min to 2.5 h, followed by a solid-phase post-condensation step which is operated at an increasing temperature within the range from 200° C. to 260° C. for a time of from 1 to 60 h.

25. Process according to the preceding embodiment, wherein the crystallizing step is operated at a temperature of from 180° C. to 200° C. for 20 min to 1.5 h.

26. Process according to either of embodiments 24 and 25, wherein the solid-phase post-condensation step is operated at an increasing temperature within the range from 210° C. to 260° C., preferably within the range from 220° C. to 250° C., for a time of from 24 h to 72 h.

27. Process according to the preceding embodiment, wherein the temperature of the solid-phase post-condensation step is increased in stages of within a range from 2 to 10° C.

28. Process according to any one of embodiments 8 to 27, wherein as a last step in said process, the polymer is employed in the form of extrusion, injection or moulding of the polyester.

### Definitions

The compounds comprising carbon that are referred to in the description may be of fossil origin or biobased. In this latter case, they may originate wholly or partly from biomass or be obtained from renewable raw materials that originate from biomass. This relates in particular to the polymers, the plasticizers, the fillers, etc.

Any range of values denoted by the expression “between a and b” represents the domain of values ranging from more than a to less than b (that is, with end points a and b excluded), whereas any range of values denoted by the expression “from a to b” signifies the domain of values ranging from a up to b (that is, including the strict end points a and b).

Unless expressly stated otherwise, the pressures are expressed as absolute values.

### Polyester According to the Invention

The invention relates to a polyester comprising ethylene 2,5-furandicarboxylate units and diethylene glycol units, said polyester having a melting temperature Tf of greater than or equal to 225° C., an intrinsic viscosity of greater than or equal to 0.65 dL/g, and in which:
the amount of diethylene glycol unit is less than 4 mol %;
the quantity of ester functions in chain end situations is less than 100 meq/kg.

The polyester according to the invention has an amount of diethylene glycol unit, denoted DEG, of less than 4 mol %, preferably less than 3 mol % and more preferably less than 2 mol %. Under certain operating conditions of the synthesis process, it is even possible to obtain a polyester having an amount of DEG unit of less than the detectability threshold. This low amount partly explains the properties of the polyester according to the invention, particularly a high melting temperature.

The polyester according to the invention has a quantity of ester functions in chain end situations of less than 100 meq/kg. Whereas the polyester described in document WO 2015/137805 has a quantity of chain-end carboxylic acid functions of between 15 and 122 meq/kg, the Applicant has found that it was of prime importance to control the quantity of ester functions in chain end situations. The combination of a low amount of DEG unit, of less than 4 mol %, and a low quantity of ester functions in chain end situations, of less than 100 meq/kg, preferably less than 80 meq/kg, and more preferably less than 70 meq/kg, allows the polyester according to the invention partly to have both a relatively high intrinsic viscosity, of greater than 0.65 dL/g, and a high melting temperature, of greater than or equal to 225° C.

The polyester according to the invention comprises very few decarboxylated chain ends. The number of decarboxylated chain ends, in relation to the number of repeat units of the polyester, is preferably less than the detectability threshold.

The number-average molar mass of the polyester according to the invention is preferably greater than 19 000 g/mol as PMMA equivalent.

The polyester according to the invention preferably has an intrinsic viscosity of between 0.65 and 0.90 dL/g.

The polyester according to the invention preferably has a dispersity, denoted D and representing the ratio of the weight-average molar mass to the number-average molar mass (D=Mw/Mn), of less than 1.9, preferably of between 1.7 and 1.9.

The melting enthalpy of the polyester according to the invention is greater than 30 J/g, preferably greater than 35 J/g. Its melting temperature is greater than or equal to 225° C., preferably greater than or equal to 230° C. The polyester according to the invention has a glass transition temperature T_{g} of between 70 and 90° C.

Process According to the Invention for Synthesizing a Polyester

Transesterifying Step

The process according to the invention comprises a step of transesterifying a composition comprising a furandicarboxylate compound, denoted RFC, of general formula (I):

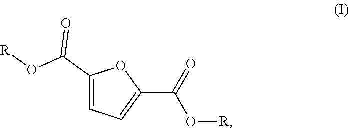

in which R represents an alkyl group comprising from 1 to 3 carbon atoms or the hydrogen atom, said composition also comprising ethylene glycol, denoted EG, this transesterifying step being operated at an increasing temperature within the range from 150° C. to at least 185° C. with a molar ratio EG/RFC of from 3 to 1.3 in the presence of a Lewis acid catalyst.

Transesterification in the present context refers not only to transesterification when R represents an alkyl group comprising from 1 to 3 carbon atoms, but also to esterification when R represents the hydrogen atom.

The transesterifying step produces ethylene-furandicarboxylate oligomers from the reaction of ethylene glycol with the furandicarboxylate compound. The operating conditions of this step have a defining influence on the structure of the polyester obtained. In the composition supplying this step, the molar ratio EG/RFC is preferably between 2 and 1.5. Below 1.3, the degree of advancement of the reaction is significantly affected, whereas beyond 3 the amount of DEG unit in the polyester becomes too great.

Preferably, R represents an alkyl group comprising from 1 to 2 carbon atoms. The compound of general formula (I) in that case corresponds to dimethyl-2,5-furandicarboxylate, or to diethyl-2,5-furandicarboxylate.

The transesterifying step is carried out for a time of preferably from 1 to 5 h, more preferably from 2 to 4 h.

In accordance with the invention, the transesterifying step is operated at an increasing temperature within the range from 150° C. to at least 185° C. By “increasing temperature within the range from 150° C. to at least 185° C.” is meant that the transesterifying step is operated at a temperature within the temperature range of from 150° C. to at least 185° C., the operating temperature being increasing during the transesterifying step. The implementation of an increasing temperature profile produces a polyester which more particularly has a very high melting temperature in particular, in combination with the other operating parameters, by the acquisition of an amount of DEG unit and of a quantity of ester functions in chain end situations that are very low.

In one preferred arrangement, the temperature increases continuously within the range from 150° C. to at least 185° C. according to a ramp of less than or equal to +1° C./min, preferably less than or equal to +0.5° C./min. When the highest temperature is reached, a plateau stage may be maintained until the degree of transesterification is greater than 80%.

In another preferred arrangement, the temperature increases within the range from 150° C. to at least 185° C. in stages within a range of from 5 to 15° C. Each stage preferably lasts independently for from 15 min to 2.5 h. Very preferably, the transesterification step is operated with at least three temperature stages.

The highest temperature at which the transesterifying step is operated is preferably within the range from 185° C. to 205° C., preferably from 185° C. to 200° C., and very preferably from 190° C. to 200° C. Below 185° C., the degree of advancement of the reaction is significantly affected, as manifested in an insufficient conversion of the ester chain ends and in an insufficient final intrinsic viscosity, whereas beyond 205° C. there is a significant increase in the amount of DEG unit in the polyester.

Preferably, the time between the end of the first stage and the start of the last stage, or between the lowest and highest temperatures in the transesterifying step when the temperature increases continuously, is at least 30 min, preferably at least 45 min. The reason is that it has been observed that, when the temperature ascent was too rapid, higher amounts of DEG unit were obtained.

It has been observed by the Applicant that the application of these specific temperature conditions makes it possible, if the other operating conditions of the invention are observed, to limit greatly the formation of diethylene glycol units in the polyester, while ensuring effective reaction kinetics.

For example, the transesterifying step may be operated for 1 h at 160° C., then 1 h at 170° C. and lastly 2 h at 195° C. In this case, the stages are respectively 10° C. and 25° C. and the respective duration of each of the three stages is 1 h, 1 h and 2 h.

The transesterifying step is preferably operated at moderate pressure, of from 0.8 to 2 bar. The step is preferably operated in an inert atmosphere. Operating at moderate pressure, or even at slight overpressure or under pressure, in other words preferably between 800 and 1700 mbar, allows the transesterifying step to be operated in liquid phase while evacuating the reaction products such as the alcohol (if R is other than H) or water (if R is the hydrogen atom).

The transesterifying step is operated in the presence of a Lewis acid catalyst. The Lewis acid catalyst is preferably selected from hafnium acetylacetonate, zirconium acetylacetonate, titanium isopropoxide (TIS) and titanium tetrabutoxide (TBT). The Lewis acid catalyst preferably is titanium tetrabutoxide (TBT), the latter producing a low proportion of DEG units and a low level of chain-end decarboxylation.

The transesterifying step is operated with an amount of catalyst of from 100 to 1000 ppm, preferably of from 150 to 500 ppm, and very preferably of from 200 to 450 ppm.

These operating conditions, with a temperature increasing in stages within the stated range and in the presence of a Lewis acid catalyst, more particularly a catalyst such as titanium tetrabutoxide (TBT), make it possible to limit greatly the formation of DEG units in the polymer, while ensuring a degree of transesterification of greater than 80%, a quantity of ester functions in chain end situations of less than 100 meq/kg, preferably less than 80 meq/kg, at the end of transesterification for the polyester prepolymer obtained. The degree of transesterification is determined by dividing the mass of alcohol (or of water when R=H) obtained from the transesterifying step by the theoretical mass of alcohol (or of water when R=H) produced on the assumption that all of the ester (or acid when R=H) functions of the compound RFC have reacted.

The amount of DEG units in the polyester formed is less than 4 mol %, or even less than 3 mol %, preferably less than 2 mol %. Under the conditions of the invention, more particularly with the use of an increasing temperature, it has been observed that the addition of agents inhibiting the formation of DEG units as described in patent application WO2015/137805, for example of ammonium compounds, more particularly tetraalkylammonium compounds, does not provide any additional effect. The process according to the invention therefore preferably does not comprise adding agents which inhibit formation of DEG units. With application of all of the preferred conditions, the amount of DEG units in the polyester obtained at the end of the process according to the invention is below the detectability limit by NMR measurement.

Polycondensation Step

The process according to the invention comprises a melt polycondensation step which is operated at a temperature within the range from 220° C. to 250° C. and a pressure of lower than 100 mbar.

At the end of the transesterifying step, the pressure is lowered gradually over a time of between 60 and 120 min, preferably between 80 and 100 min, to reach the operating pressure of the polycondensation step. When the pressure is less than 400 mbar, preferably less than 300 mbar and very preferably less than 200 mbar, the temperature of the reaction mixture is increased until it reaches the initial operating temperature of the polycondensation step. The temperature lift to the initial operating temperature of the polycondensation step is carried out over a time of from 15 to 45 min.

The use of a low operating pressure, and particularly the pressure-lowering phase, results in gradual evacuation of the ethylene glycol present in the reaction system. The polycondensation step is operated preferably at an increasing temperature within the range from 220° C. to 250° C. The temperature preferably increases within the range from 225° C. to 240° C. in stages of within a range of from 2 to 10° C. Each stage preferably lasts independently for from 15 min to 2.5 h. The applicant has observed that the application of an increasing temperature profile during the polycondensation step makes it possible to limit the formation of DEG units in the polyester.

For example, the polycondensation step may be operated for 1 h at 230° C., then 1 h at 240° C. In this case, each stage, namely the difference in temperature between two successive operating temperatures, is 10° C., and the respective duration of each of the two stages is 1 h and 2 h.

The implementation of increasing temperatures for the transesterifying and polycondensation steps is therefore particularly advantageous in terms of controlling the structure of the polyester obtained. These temperatures make it possible in particular to obtain a polyester in which the quantity of decarboxylated chain ends is below the detectability limit.

The polycondensation step is carried out for a time of preferably from 1 to 5 h, more preferably from 2 to 4 h. This step is operated under low pressure, preferably at a pressure of lower than 100 mbar, very preferably at a pressure of lower than 50 mbar. These particular conditions allow a very low amount of DEG units to be maintained in the polyester, and even amounts below the detectability limits.

The polycondensation step is operated with an amount of catalyst of from 100 to 1000 ppm, preferably of from 150 to 500 ppm, and very preferably of from 200 to 450 ppm. The catalyst is generally added to the reaction system during the transesterifying step. A further addition of catalyst, identical to or different from that used during the transesterifying step, may be made if necessary during the polycondensation step.

The polyester obtained at the outcome of this step, which is referred to as polycondensate, may subsequently be shaped, either in the form of pellets or in the form of a thread or in the form of a film. Shaping in thread form may be accomplished through a spinning system, as known to the skilled person, so as to give a thread which can be used as it is or else as an assembly of threads. Shaping in thread form may be accomplished, for example, by passage over a series of temperature-controlled spools which allow the thread to be drawn to the desired diameter. Shaping in a film form may be accomplished by passing the polycondensate over a series of cooled rollers so as to form a film.

The polycondensate is preferably cooled rapidly by contacting with water and is pelletized. This rapid contacting makes it possible to limit the agglomeration of the pellets to one another. This pelletizing step is conducted so as to form pellets of substantially uniform size, so as to facilitate subsequent operations.

In this preferred arrangement, the pellets are subsequently dried at a temperature of from 80° C. to 100° C. at a pressure lower than or equal to the atmospheric pressure in an inert atmosphere, for example in a nitrogen atmosphere.

The polyester obtained at the end of the polycondensation step is substantially amorphous.

The polyester obtained at the end of the polycondensation step has an intrinsic viscosity of between 0.35 and 0.50 dL/g. This intrinsic viscosity is linked to the molar mass of the polyester—the higher the molar mass of the polyester, the greater the intrinsic viscosity. The intrinsic viscosity of the polyester is preferably between 0.4 and 0.50 dL/g.

Crystallizing Step

Following the shaping of the polyester in pellet form, it is possible to operate a crystallizing step at a temperature of between the crystallizing temperature and the melting temperature of the polyester. This step increases the crystallinity of the polyester.

For the crystallization to be able to take place, the crystallizing step is operated at a temperature of from 150° C. to 210° C. for a time of from 15 min to 2.5 h, and is preferably operated at a temperature of from 180° C. to 200° C. for 20 min to 1.5 h.

Solid-State Post-Condensation Step

In order to increase the average molar mass of the polyester obtained and its melting temperature, following the crystallizing step, a solid-state post-condensation step is advantageously carried out. This step is implemented by heating the polyester to a temperature close to and lower than its melting temperature.

Accordingly, the solid-phase post-condensation step is operated at an increasing temperature within the range from 210° C. to 260° C., preferably within the range from 220° C. to 250° C., for a time of from 24 h to 72 h. The temperature of the solid-phase post-condensation step is preferably increased in stages of within a range from 2 to 10° C.

By operating this step with an increasing temperature within the range from 210° C. to 260° C., preferably within the range from 220° C. to 250° C., and preferably by increasing this temperature in stages of within a range from 2 to 10° C., preferably from 3 to 5° C., the molar mass increase and the melting temperature of the polyester obtained are maximized. Moreover, and surprisingly, the melting zone, namely the temperature range which is visible on the thermogram obtained by DSC according to the method described later on below in the present text, and in which melting is observed, is significantly reduced relative to that of the polyesters obtained by prior-art processes.

At the end of the solid-state post-condensation step, the intrinsic viscosity of the polyester is increased, and is preferably between 0.65 and 0.90 dL/g.

Shaping Step

The polyester obtained at the end of this post-condensation step may subsequently be shaped, either in the form of pellets or in the form of a thread or in the form of a film. Shaping in thread form may be accomplished through a spinning system, as known to the skilled person, so as to give a thread which can be used as it is or else can be used as an assembly of threads. Shaping in thread form may be accomplished, for example, by extrusion of molten polymer through a die pack bearing a multitude of sub-millimetre holes for producing the same quantity of filament. The multi-filament may then be cooled, provided with sizing, and drawn over a series of godets at controlled temperature to give the desired geometric and thermomechanical characteristics. These steps may be accomplished in a single pass or in two or more passes.

The shaping of a film may be accomplished by extruding the molten polycondensate and then passing it over a series of cooled rollers so as to form a film of controlled thickness. Extrusion-blow moulding or thermoforming procedures may be applied to shape these films.

The pellets described below represent semi-finished products which can be subsequently shaped using the conventional plastics processing techniques (injection, moulding, extrusion, etc.). The semicrystalline character of the polymer may more particularly be of advantage for producing hollow bodies with the formation of an amorphous preform from pellets and then the blow moulding of said preform between the glass transition temperature and the crystallite melting temperature in a mould.

With regard to all of the applications, the service thermal stability of the component will be greater the higher its melting temperature and more specifically will be greater the higher the highest possible temperature at which the melting phenomenon begins.

Furthermore, for all of the shaping operations involving crystallization, a lower crystallization temperature produces more gentle and less energy-consuming operating conditions. Accordingly, for a semicrystalline polymer, the greatest possible difference between the melting temperature and the crystallization temperature is particularly valuable.

Measurement Methods

Quantity of Ester Functions in Chain End Situations

The quantity of ester functions in chain end situations is measured by NMR spectroscopy.

This measurement is carried out either in HFIP-d (deuterated hexafluoro-2-propanol) to look at the alcohol chain ends, or in a 25/75 vol/vol TFA-d/CDCl3 mixture, to study the ester chain ends and determine the proportion of DEG, where TFA-d represents deuterated trifluoroacetic acid and CDCl3 represents deuterated chloroform.

The molar % age of chain ends per unit is calculated as follows:

$$alcohol chain end per repeat unit = \frac{\frac{\int alpha - CH 2 alcohol signal}{2}}{\frac{\int furan signal}{2}}$$

$$ester chain end per repeat unit = \frac{\frac{\int ester CH 3 signal}{3}}{\frac{\int furan signal}{2}}$$

The decarboxylated signals are not observable in the process according to the invention, and are therefore disregarded.

Method for Measuring the Amount of DEG Units

The quantity of DEG units is measured by NMR spectroscopy.

A value 200 is given to the furan signal, which is integrated between 7.29 and 7.36 ppm (number of furan protons per 100 repeating units), and then the following formula is applied:

$$molar \% DEG relative to the furans = \frac{\frac{\int alpha - CH 2 ether signal}{4}}{\frac{\int furan signal}{2}} * 100$$

The % DEG is Therefore Expressed Per 100 Repeat Units.

Glass transition, melting and crystallization temperatures

The glass transition temperature Tg, melting temperature Tf and crystallization temperature are measured in a known way by differential scanning calorimetry or DSC according to standard ISO 11357-2 of March 2020 for the glass transition temperature and standard ISO 11357-3 of March 2018 for the melting and crystallization temperatures and enthalpies, with the following modification: the temperature ramp applied is 1.5 K/min, rather than the recommended ramp of 10 K/min or 20 K/min, since the latter rate of temperature variation does not enable correct determination of the crystallization and melting temperature.

When the ramp of 20 K/min is applied, the melting temperatures measured are around 8° C. higher than the temperatures measured with the ramp of 1.5 K/min.

The Tg, the hot and cold crystallization temperatures, the degree of crystallinity and the Tf were measured by DSC, the cycle performed being as follows:

An ascent from 20° C. to 260° C., an isotherm of 5 min at 260° C. followed by a descent in temperature from 260° C. to 20° C., then an isotherm of 5 min at 20° C., and lastly a final ascent from 20° C. to 260° C. The rate was always set at 1.5° C./min, in ascent and in descent.

Intrinsic Viscosity (IV)

The intrinsic viscosity (IV) is measured in solution, in a phenol/ortho-dichlorobenzene mixture.

The polymers are dissolved at a concentration C equal to 5 g/L in a mixture of equal masses of phenol/ortho-dichlorobenzene. To promote dissolution, the mixture of the solvent and the pellets is placed under vigorous stirring at 120° C. for a number of minutes. Lastly, before being introduced into the Ubbelohde capillary viscometer, the solution is filtered using 0.45 μm PTFE filters.

The intrinsic viscosity (IV) is measured at 25° C. and calculated by means of the following formulae:

$$η ( intristic ) = \frac{\sqrt{2}}{C} \times \sqrt{( η ( specific ) - ln ( η ( relative ) )}$$

Here, C is the concentration of the solution, and the specific and relative viscosities can be calculated by the following formulae:

η(specific)=(η−η0)/η0

η(relative)=η/η0

where η0 corresponds to the viscosity of the solvent alone and η to the viscosity of the macromolecular solution.

Measuring the Crystallinity of the Polymer

The crystallinity of the polymer is determined by the following formula: ((ΔHm sample−ΔHc sample)/ΔHm°)*100, where ΔHm sample is the melting enthalpy on first ascent, ΔHc sample is the cold crystallization enthalpy in first ascent, and ΔHm° is the standard melting enthalpy of PEF (137 J/g)).

Measurement by Size Exclusion Chromatography (SEC)

The SEC analyses are executed in hexafluoroisopropanol (HFIP). The solutions are prepared at a concentration of 1 mg/mL. Prior to analysis, the samples are filtered using 0.45 μm PTFE filters.

The sample for analysis is introduced into APC XT columns by means of an automatic sample injector (Sample Manager pFTN) and a Waters Acquity Advanced Polymer Chromatography (APC) pump. An automatic sample changer (Sample Manager pFTN) switches to the following sample.

SEC method for expressing the Mn as a PMMA equivalent:

The molar masses are evaluated by means of a differential refractive index detector (Waters RI detector) which allows the relative molar mass of our polymers to be obtained on the basis of a calibration plot constructed using PMMA standards at 35° C.

### EXAMPLES

In the examples which follow, the pressures are expressed in bar absolute.

### Example 1

A transesterifying step is supplied with a composition comprising dimethyl furandicarboxylate (DMF) and ethylene glycol (EG) with a molar ratio EG/DMF of 1.7. This composition is contacted with 400 ppm of titanium tetrabutoxide (TBT) catalyst.

The transesterifying step is operated at 1.5 bar with a temperature progressing from 160° C. to 194° C. with a temperature ramp of +0.2° C./min for 3 h, with the highest temperature being maintained once it has been reached.

At the end of this step, a prepolymer is obtained in which the presence of DEG unit is not detectable. The degree of transesterification is 82%.

The pressure of the reaction mixture is lowered to 200 mbar over 20 min, while the temperature is maintained in a first phase at 194° C. When the pressure reaches 200 mbar, the temperature is increased to reach 230° C. over 30 min, while the decrease in pressure is continued. Lastly, 40 min after having reached 230° C., in other words when P is <1.3 mbar, the polycondensation step is triggered, during which the temperature is maintained at 230° C. for 1 h, and then taken to 240° C. and maintained for 1 h.

At the end of the polycondensation step, the polycondensate is cooled rapidly by contacting it with water and is pelletized.

The PEF polyester obtained at the end of the polycondensation step has the following characteristics:
Intrinsic viscosity (IV): 0.40 dL/g
Amount of DEG unit: 1.8 mol % relative to the furan unit
Amount of alcohol chain end: 150 meq/kg
Quantity of ester functions in chain end situations: 61 meq/kg
Amount of decarboxylated chain end: not detected
Number-average molar mass Mn (PMMA equivalent): 21600 g/mol
Dispersity (D): 1.7
Glass transition temperature: 82° C.
Crystallization temperature: 150° C.
Crystallization enthalpy: 45 J/g
Degree of crystallinity: 0% (ΔH_{f}°=137 J/g)

The pellets obtained are subsequently dried for 5 h at 100° C. and then treated in a crystallization step in which they are taken to a temperature of 190° C. for 1.5 h.

At the end of the crystallization, a solid-state post-condensation step is implemented by taking the pellets to a temperature of 217° C. for 6 h, then to a temperature of 227° C. for 34 h, in a stream of nitrogen.

The polyester obtained at the end of this step has the following characteristics:
Intrinsic viscosity (IV): 0.71 dL/g
Degree of crystallinity: 52%
Melting temperature: 234.5° C.

The melting temperature measured by applying a 20 K/min temperature ramp as recommended in standard ISO 11357-3 of March 2018 is 242.5° C.

### Example 2

A transesterifying step is supplied with a composition comprising dimethyl furandicarboxylate (DMF) and ethylene glycol (EG) with a molar ratio EG/DMF of 1.7. This composition is contacted with 400 ppm of titanium tetrabutoxide (TBT) catalyst.

The transesterifying step is operated at 1.5 bar with a temperature progressing from 160° C. to 180° C. with a temperature ramp of +0.2° C./min for 3 h, with the highest temperature being maintained once it has been reached.

At the end of this step, a prepolymer is obtained in which the presence of DEG unit is not detectable. The degree of transesterification is 73%.

The pressure of the reaction mixture is lowered to 200 mbar over 20 min, while the temperature is maintained in a first phase at 180° C. When the pressure reaches 200 mbar, the temperature is increased to reach 230° C. over 30 min, while the decrease in pressure is continued. Lastly, 40 min after having reached 230° C., in other words when P is <1.3 mbar, the polycondensation step is triggered, during which the temperature is maintained at 230° C. for 1 h, and then taken to 240° C. and maintained for 1 h.

At the end of the polycondensation step, the polycondensate is cooled rapidly by contacting it with water and is pelletized.

The PEF polyester obtained at the end of the polycondensation step has the following characteristics:
Intrinsic viscosity (IV): 0.39 dL/g
Amount of DEG unit: 1.4 mol % relative to the furan unit
Amount of alcohol chain end: 112 meq/kg
Quantity of ester functions in chain end situations: 127 meq/kg
Amount of decarboxylated chain end: not detected
Number-average molar mass Mn (PMMA equivalent): 18100 g/mol
Dispersity (D): 1.8
Glass transition temperature: 85° C.
Crystallization temperature: 161° C.
Crystallization enthalpy: 44.3 J/g
Crystallinity: 0% (ΔH_{f}°=137 J/g)

The pellets obtained are subsequently dried for 5 h at 100° C. and then treated in a crystallization step in which they are taken to a temperature of 190° C. for 1.5 h.

At the end of the crystallization, a solid-state post-condensation step is implemented by taking the pellets to a temperature of 217° C. for 6 h, then to a temperature of 227° C. for 34 h, in a stream of nitrogen.

The polyester obtained at the end of this step has the following characteristics:
Intrinsic viscosity (IV): 0.55 dL/g
Crystallinity: 50%
Melting temperature: 232.5° C.

It is noted that the polyester obtained exhibits a less favourable trade-off between melting temperature/intrinsic viscosity relative to the polymer obtained in example 1, with more particularly an IV lower than 23%.

### Example 3

A transesterifying step is supplied with a composition comprising dimethyl furandicarboxylate (DMF) and ethylene glycol (EG) with a molar ratio EG/DMF of 1.7. This composition is contacted with 400 ppm of titanium tetrabutoxide (TBT) catalyst.

The transesterifying step is operated at 1.5 bar with a temperature progressing from 180° C. to 230° C. with a temperature ramp of +0.5° C./min for 1.5 h, with the temperature being subsequently maintained at 230° C. for 40 min.

The pressure of the reaction mixture is lowered to 200 mbar over 20 min, while the temperature is maintained in a first phase at 230° C. When the pressure reaches 200 mbar, the temperature is increased to reach 240° C. over 20 min, while the decrease in pressure is continued. Lastly, 50 min after having reached 240° C., in other words when P is <1.3 mbar, the polycondensation step is triggered, during which the temperature is maintained at 240° C. for 3 h.

At the end of the polycondensation step, the polycondensate is cooled rapidly by contacting it with water and is pelletized.

The PEF polyester obtained at the end of the polycondensation step has the following characteristics:
Intrinsic viscosity (IV): 0.5 dL/g
Amount of DEG unit: 5.4 mol % relative to the furan unit
Number-average molar mass Mn (PMMA equivalent): 26000 g/mol
Dispersity (D): 1.8
Crystallization temperature: 169° C.
Crystallinity: 0% (ΔH_{f}°=137 J/g)

The pellets obtained are subsequently dried for 5 h at 100° C. and then treated in a crystallization step in which they are taken to a temperature of 180° C. for 3 h.

At the end of the crystallization, a solid-state post-condensation step is implemented by taking the pellets to a temperature of 200° C. for 48 h in a stream of nitrogen.

The polyester obtained at the end of this step has the following characteristics:
Intrinsic viscosity (IV): 0.7 dL/g
Melting temperature: 218° C.

The severe transesterification conditions combined with the other synthesis steps produce a polyester which has a high viscosity, to the detriment of its melting temperature.

1.-13. (canceled)

14. A polyester comprising ethylene 2,5-furandicarboxylate units and diethylene glycol units, the polyester having a melting temperature Tf of greater than or equal to 225° C., an intrinsic viscosity of greater than or equal to 0.65 dL/g,
wherein an amount of diethylene glycol unit, denoted DEG, is less than 4 mol %, and
wherein a quantity of ester functions in chain end situations is less than 100 meq/kg.

15. The polyester according to claim 14, wherein the melting temperature Tf is greater than or equal to 230° C.

16. The polyester according to claim 14, wherein the polyester has a dispersity of less than 1.9.

17. The polyester according to claim 14, wherein a glass transition temperature T_{g} is between 70 and 90° C.

18. A process for preparing a polyester, the process comprising successively:
a step of tranesterifying a composition comprising a furandicarboxylate compound of general formula (I) 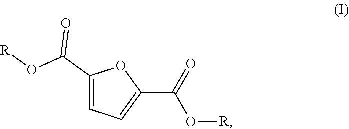
in which R represents an alkyl group comprising from 1 to 3 carbon atoms or the hydrogen atom,
the composition further comprising ethylene glycol, and the transesterifying step being operated at an increasing temperature in a range from 150° C. to at least 185° C. with a molar ratio of ethylene glycol to furandicarboxylate compound of from 3 to 1.3 in the presence of a Lewis acid catalyst; and
a melt polycondensation step operated at an increasing temperature within a range from 220° C. to 250° C. and a pressure of less than 100 mbar, to give the polyester.

19. The process according to claim 18, wherein R in the compound of general formula (I) represents an alkyl group comprising from 1 to 2 carbon atoms.

20. The process according to claim 18, wherein a highest temperature at which the transesterifying step is operated is within a range from 185° C. to 205° C.

21. The process according to claim 18, wherein the temperature in the transesterifying step increases continuously within a range from 160° C. to at least 185° C. according to a ramp of less than or equal to +1° C./min.

22. The process according to claim 18, wherein the temperature in the transesterifying step increases within a range from 160° C. to at least 185° C. in stages of within a range from 5 to 15° C.

23. The process according to claim 18, wherein the Lewis acid catalyst used in the transesterifying step is selected from hafnium acetylacetonate, zirconium acetylacetonate, titanium isopropoxide and titanium tetrabutoxide.

24. The process according to claim 18, wherein, following the melt polycondensation step, a shaping step is performed in which the polycondensate is cooled rapidly by contacting with water and is pelletized, and then dried at a temperature of from 80° C. to 100° C. at a pressure less than or equal to the atmospheric pressure in an inert atmosphere.

25. The process according to claim 24, wherein, following the shaping step, a crystallizing step is carried out, which is operated at a temperature of from 150° C. to 210° C. for a time of from 15 min to 2.5 h, followed by a solid-phase post-condensation step which is operated at an increasing temperature within a range from 200° C. to 260° C. for a time of from 1 to 60 h.

26. The process according to claim 18, wherein, as a last step, the polyester is extruded, injected or molded.
